(19) United States
(12) Patent Application Publication
(10) Pub. No.: US 2023/0334601 A1
(43) Pub. Date: Oct. 19, 2023

(54) METHODS, INTERNET OF THINGS SYSTEMS, AND STORAGE MEDIUMS FOR DYNAMICALLY MANAGING WORK ORDERS OF SMART GAS PLATFORMS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Xiaojun WEI, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 18/337,457

(22) Filed: Jun. 20, 2023

(51) Int. Cl. G06Q 50/06; G06Q 10/0631; G06Q 10/0633

(52) U.S. Cl. CPC G06Q 50/06; G06Q 10/06316; G06Q 10/0633

(57) ABSTRACT

The present disclosure provides methods and Internet of Things systems for dynamically managing a work order of a smart gas platform. The method includes: obtaining real-time data of a gas work order; determining warning work order information and current handler information of a warning work order based on the real-time data of the gas work order; determining a working hour requirement of the warning work order according to the warning work order information and the current handler information; predicting an on-time processing probability of the warning work order based on the working hour requirement, a required completion time, and a work order status; and in response to a determination that the on-time processing probability does not meet a preset probability condition, adjusting a processing scheme of the warning work order.

### TECHNICAL FIELD

The present disclosure relates to the technical field of the Internet of Things, and in particular, to methods and Internet of Things systems for dynamically managing work orders of smart gas platforms.

### BACKGROUND

At present, gas has been widely used in many fields of social life and production, but the gas pipeline network will inevitably fail in the process of transporting gas. In order to be able to respond to the failure and handle it in a timely manner, maintenance personnel are mainly assigned to repair the failure through the distribution of failure work orders by the gas platform. In terms of a gas failure work order, on the one hand, a processing time of a gas failure fluctuates greatly, for example, a certain work order takes a long time to process, which may affect the processing of subsequent tasks; on the other hand, whether the gas can be used normally not only affects people's daily life but also has a relatively great safety risk if the gas failure is not handled in time. Therefore, the processing of the gas failure work order requires a high level of timeliness.

In terms of how to distribute work orders and improve processing efficiency, CN109858746A proposes methods for distributing failure work orders and systems for managing failure work orders. The focus of the CN109858746A is to determine a level of the failure type based on a type of failure work order and match best maintenance personnel based on the level of the failure type, but does not involve a timeliness requirement for processing a work order and probability prediction of completing the work order on time.

Therefore, it is desirable to provide methods and Internet of Things systems for dynamically managing work orders of smart gas platforms, to improve the timeliness of processing the failure work order of the gas platform.

### SUMMARY

One or more embodiments of the present disclosure provide a method for dynamically managing a work order of a smart gas platform. The method is implemented by a smart gas management platform of an Internet of Things system for dynamically managing a work order of a smart gas platform and includes: obtaining real-time data of a gas work order; determining warning work order information and current handler information of a warning work order based on the real-time data of the gas work order; determining a working hour requirement of the warning work order according to the warning work order information and the current handler information, the warning work order information including at least one of a work order difficulty, a work order type, or a gas failure type in the warning work order information; predicting an on-time processing probability of the warning work order based on the working hour requirement, a required completion time, and a work order status; and in response to a determination that the on-time processing probability does not meet a preset probability condition, adjusting a processing scheme of the warning work order, the processing scheme including at least one of a processing sequence or a handler arrangement.

One or more embodiments of the present disclosure provide an Internet of Things system for dynamically managing a work order of a smart gas platform. The Internet of Things system includes a smart gas user platform, a smart gas service platform, a smart gas management platform, a smart gas sensor network platform, and a smart gas object platform. The smart gas management platform is configured to: obtain real-time data of a gas work order; determine warning work order information and current handler information of a warning work order based on the real-time data of the gas work order; determine a working hour requirement of the warning work order according to the warning work order information and the current handler information, the warning work order information including at least one of a work order difficulty, a work order type, or a gas failure type in the warning work order information; predict an on-time processing probability of the warning work order based on the working hour requirement, a required completion time, and a work order status; and in response to a determination that the on-time processing probability does not meet a preset probability condition, adjust a processing scheme of the warning work order, the processing scheme including at least one of a processing sequence or a handler arrangement.

One or more embodiments of the present disclosure provide a non-transitory computer-readable storage medium storing computer instructions. A computer implements the method for dynamically managing a work order of a smart gas platform when reading the computer instructions stored in the storage medium.

In some embodiments of the present disclosure, by predicting the on-time processing probability of the warning work order, the processing scheme of the warning work order may be effectively adjusted based on the on-time processing probability, which improves the flexibility and initiative of dynamic management of the work order and is conducive to completing the gas work order timely and reducing a safety risk caused by untimely processing of the gas work order.

### BRIEF DESCRIPTION OF THE DRAWINGS

FIG. 1 is a platform structure diagram illustrating an Internet of Things system for dynamically managing a work order of a smart gas platform according to some embodiments of the present disclosure;

FIG. 2 is a flowchart illustrating an exemplary process for dynamically managing a work order of a smart gas platform according to some embodiments of the present disclosure;

FIG. 3 is a flowchart illustrating an exemplary process for determining a working hour requirement based on a warning work order feature vector according to some embodiments of the present disclosure;

FIG. 4 is a flowchart illustrating an exemplary process for predicting an on-time processing probability according to some embodiments of the present disclosure;

FIG. 5 is a schematic diagram illustrating an on-time prediction model according to some embodiments of the present disclosure; and

FIG. 6 is a flowchart illustrating an exemplary process for adjusting a processing scheme of a warning work order according to some embodiments of the present disclosure.

### DETAILED DESCRIPTION

A brief introduction of the drawings referred to the description of the embodiments is provided below. The drawings do not represent all embodiments.

Different gas failures have different processing time requirements. In order to improve timeliness of processing a failure work order, time as a factor needs to be considered when the failure work order is assigned. Therefore, in some embodiments of the present disclosure, a gas warning work order may be determined according to real-time data of a gas work order and a working hour requirement of the gas work order may be determined based on gas warning work order information and current handler information. Further, an on-time processing probability of the warning work order may be predicted, and a processing scheme of the warning work order may be adjusted based on the on-time processing probability, which can improve the timeliness of processing the failure work order and ensure order and safety of people's daily life.

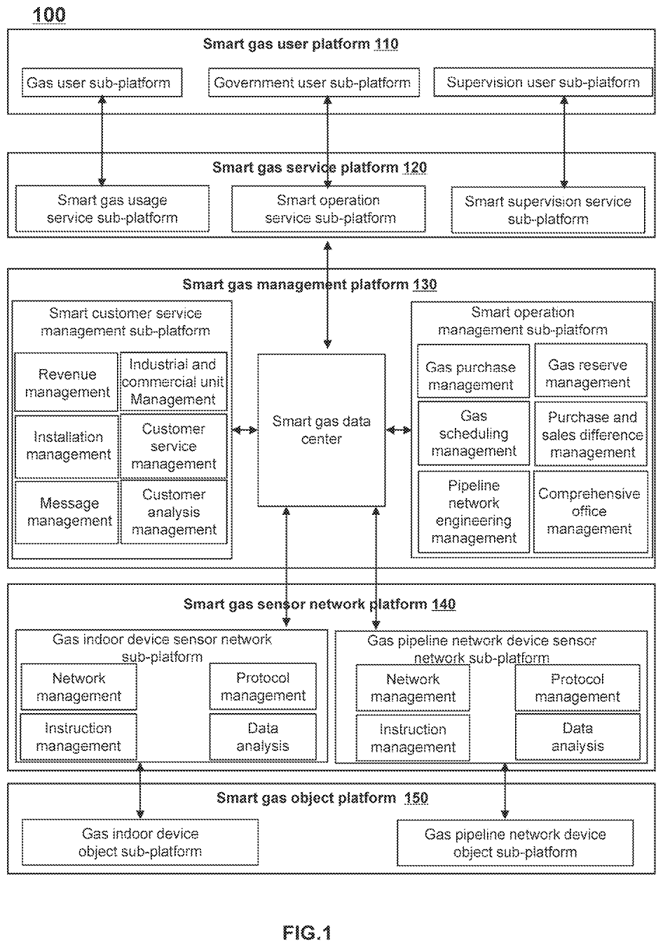

FIG. 1 is a platform structure diagram illustrating an Internet of Things system for dynamically managing a work order of a smart gas platform according to some embodiments of the present disclosure. In some embodiments, the Internet of Things system 100 for dynamically managing a work order of a smart gas platform may include a plurality of platforms interacting sequentially.

A smart gas user platform 110 refers to a platform that is user-oriented and interacts with a user. The user may be a gas user, a government user, a supervision user, etc. In some embodiments, the smart gas user platform 110 may be configured as a terminal device. In some embodiments, the smart gas user platform 110 may feed information back to the user through the terminal device.

In some embodiments, the smart gas user platform 110 may include a gas user sub-platform, a government user sub-platform, and a supervision user sub-platform. For example, the gas user may be an industrial gas user, a commercial gas user, an ordinary gas user, or the like. The government user sub-platform is targeted at the government user and can provide data related to gas operation. The supervision user sub-platform is targeted at the supervision user and can supervise operation of the entire Internet of Things system. The supervision user refers to a user of a gas safety supervision department.

In some embodiments, the gas user sub-platform, the government user sub-platform, and the supervision user sub-platform can perform data interaction with a smart gas usage service sub-platform of a smart gas service platform 120.

The smart gas service platform 120 may be a platform for receiving and transmitting data and/or information.

In some embodiments, the smart gas service platform 120 may include the smart gas usage service sub-platform, a smart operation service sub-platform, and a smart supervision service sub-platform. The smart gas usage service sub-platform may exchange data with the gas user sub-platform to provide the gas user with information related to a gas device. The smart operation service sub-platform may exchange data with the government user sub-platform to provide the government user with information about gas operation management. The smart supervision service sub-platform may exchange data with the supervision user sub-platform to provide the supervision user with information about gas system monitoring.

In some embodiments, the smart gas service platform 120 may interact with a smart gas management platform 130. For example, the smart operation service sub-platform may issue a query instruction for operation management information. As another example, the smart supervision service sub-platform may receive the information about gas operation management uploaded by the smart gas management platform 130.

The smart gas management platform 130 refers to a platform for overall planning and coordinating connection and collaboration between various functional platforms. In some embodiments, the smart gas management platform 130 may include a smart customer service management sub-platform, a smart operation management sub-platform, and a smart gas data center. The smart customer service sub-platform and the smart operation management sub-platform respectively perform bidirectional interaction with the smart gas data center.

The smart gas data center may summarize and store all operating data of the method and Internet of Things system 100 for dynamically managing a work order of a smart gas platform. In some embodiments, the smart gas management platform 130 may perform data interaction with a smart gas sensor network platform 140 and the smart gas service platform 120 (e.g., the smart operation service sub-platform) through the smart gas data center.

The smart customer service management sub-platform and the smart operation management sub-platform may obtain, analyze, and process all the operating data of the Internet of Things system 100 for dynamically managing a work order of a smart gas platform through the smart gas data center.

In some embodiments, the smart customer service management sub-platform may include modules configured for revenue management, industrial and commercial unit management, installation management, customer service management, installation management, and customer analysis management. In some embodiments, the smart operation management sub-platform may include modules configured for gas purchase management, gas reserve management, gas scheduling management, purchase and sales difference management, pipeline network engineering management, and comprehensive office management.

The smart gas sensor network platform 140 may be a functional platform for managing sensor communication. In some embodiments, the smart gas sensor network platform 140 may include a gas indoor device sensor network sub-platform and a gas pipeline network device sensor network sub-platform. In some embodiments, the smart gas sensor network platform 140 may be configured as a communication network and a gateway for network management, protocol management, instruction management, data analysis, or any combination thereof.

In some embodiments, the gas indoor device sensor network sub-platform and the gas pipeline network device sensor network sub-platform may obtain data related to a gas indoor device and data related to a gas pipeline network uploaded by a gas indoor device object sub-platform and a gas pipeline network device object sub-platform, respectively.

In some embodiments, the smart gas sensor network platform 140 may perform data interaction with the smart gas management platform 130 and a smart gas object platform 150 to realize functions of perceptual information sensor communication and control information sensor communication. For example, the smart gas sensor network platform 140 may receive the data related to the gas device uploaded by the smart gas object platform 150 or issue an instruction for obtaining the data related to the gas device to the smart gas object platform 150. As another example, the smart gas sensor network platform 140 may receive the instruction for obtaining the data related to the gas device issued by the smart gas data center and upload the data related to the gas device to the smart gas data center.

The smart gas object platform 150 refers to a functional platform for obtaining perceptual information. In some embodiments, the smart gas object platform may include the gas indoor device object sub-platform and the gas pipeline network device object sub-platform. In some embodiments, the smart gas pipeline network device object platform may be configured as various types of devices, including the gas device and other devices. In some embodiments, the gas device may include the indoor device and the pipeline network device.

In some embodiments, the gas indoor device object sub-platform may upload the data related to the indoor device to the smart gas data center through the gas indoor device sensor network sub-platform. In some embodiments, the gas pipeline network device object sub-platform may upload the data related to the gas pipeline network device to the smart gas data center through the gas pipeline network device sensor network sub-platform.

After understanding the principle of the system, for those skilled in the art, the Internet of Things system 100 for dynamically managing a work order of a smart gas platform may be applied to any suitable scenario without departing from the principle.

It should be noted that the above description of the Internet of Things for dynamically managing a work order of a smart gas platform and components thereof are provided merely for the convenience of illustration and not intended to limit the present disclosure to the scope of the embodiments. It can be understood that for those skilled in the art, after understanding the principle of the system, it is possible to combine various components arbitrarily or form a sub-system to connect with other components without departing from the principle. For example, each component may share one storage device, or each component may have its own storage device. Such deformations are within the protection scope of the present disclosure.

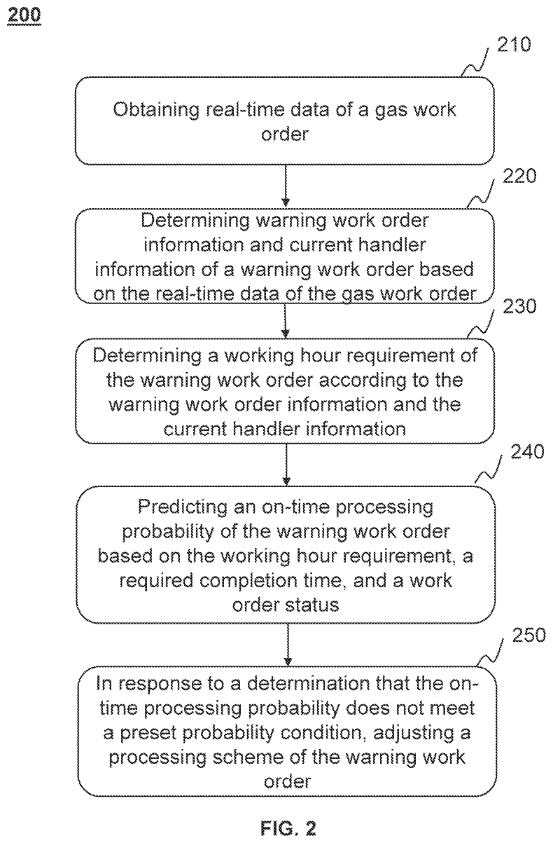

FIG. 2 is a flowchart illustrating an exemplary process for dynamically managing a work order of a smart gas platform according to some embodiments of the present disclosure. As shown in FIG. 2, the process 200 includes the following operations. In some embodiments, the process 200 may be executed by the smart gas management platform 130.

In 210, obtaining real-time data of a gas work order.

The gas work order includes a work order for recording and tracking a processing situation of a gas-related task (e.g., gas installation, gas repair).

The real-time data of the gas work order may include real-time data related to the gas work order obtained in real time. In some embodiments, the real-time data of the gas work order may include a current status and a remaining completion time of the work order. The current status of the work order refers to a status of the work order at a current time. For more descriptions of the work order status, please refer to FIG. 2 and its related descriptions.

In some embodiments, the remaining completion time may be determined based on a preset required completion time, and the required completion time may be preset according to a factor such as a work order creation time, a work order urgency level, or a customer requirement.

The required completion time refers to a time required to complete the gas work order. For example, the required completion time of a work order A may be before 12:00 am the next day. The required completion time may be preset based on the factor such as the work order creation time, the work order urgency level, or the customer requirement.

Data of the current status of the work order may be obtained through a status reported on a terminal device by a handler who receives the gas work order. The remaining completion time may be determined based on a current time of processing the gas work order and the required completion time of the work order. In some embodiments, a duration between the current time of the gas work order and the required completion time of the work order may be determined as the remaining completion time. For example, the remaining completion time may include “when the current time of the gas work order is 13:00, and the required completion time of the work order is 13:00 tomorrow, the remaining completion time is 24 hours.”

In 220, determining warning work order information and current handler information of a warning work order based on the real-time data of the gas work order.

The warning work order refers to a work order to be completed whose remaining completion time is not smaller than or equal to a warning threshold. In some embodiments, the warning threshold may be related to an average completion time of work orders of a difficulty and type. The difficulty and type may be the same as the difficulty and type of the warning work order. For example, the warning threshold may be determined by adding a length of time (e.g., 1 h) to the average completion time. For example, if an average completion time of a gas work order to be completed of a certain difficulty and type is 12 hours, the warning threshold may be determined as 13 hours. If a remaining completion time of the gas work order to be completed is 10 hours, the gas work order to be completed is determined as the warning work order.

In some embodiments, the warning work order information may at least include at least one of a work order difficulty, a work order type, or a gas failure type of the warning work order. The work order type of the gas work order at least includes a gas failure repair category, a gas pipeline change category, or the like.

An evaluation of the work order difficulty of the gas work order is related to the work order type. A work order difficulty of the gas failure repair category is determined based on the gas failure type and an impact on gas usage. For more descriptions about the work order type, please refer to the operation 310 and its related descriptions.

In some embodiments, a work order difficulty of the gas pipeline change category is determined based on a complexity level of a pipeline network structure and a degree of a gas pipeline change.

The gas pipeline change category may include an installation change for a new user, a gas relocation change for an old user, and a renovation change for an old pipeline.

The complexity level of the pipeline network structure may be determined based on a factor such as a count of pipelines, a count of pipeline branches, a count of components, or a density of the pipeline network.

In some embodiments, the degree of the gas pipeline change may be represented by a ratio of gas pipelines that need to be changed to the gas pipeline network structure. A ratio of a gas pipeline to the gas pipeline network structure may be calculated based on a length of the gas pipeline, the count of components, etc. The length of the gas pipeline includes a total length of a pipeline, a length of pipelines that need to be changed, and a length of pipelines affected by the gas pipeline change. The count of components includes a total count of components, a count of components that need to be changed, and a count of components affected by the gas pipeline change. For example, a ratio of the length of pipelines that need to be changed and the length of the pipelines affected by the gas pipeline change to the total length of the pipeline may be determined as the degree of the gas pipeline change. As another example, a ratio of the count of components that need to be changed and the count of components affected by the gas pipeline change to the total count of components may be determined as the degree of the gas pipeline change.

The current handler refers to a staff member who processes the current warning work order.

In some embodiments, the current handler information may at least include a work order processing record. The work order processing record may be information about similar work orders that the current handler has processed before. The work order processing record may include a count of the similar work orders that have been processed and a count of the similar work orders that have been processed successfully by the current handler.

In some embodiments, the smart gas management platform 130 may obtain information related to the warning work order from a smart gas data center. The information related to the warning work order includes the warning work order information and the current handler information of the warning work order.

In 230, determining a working hour requirement of the warning work order according to the warning work order information and the current handler information.

The working hour requirement refers to a working hour required by the current handler to process and complete the warning work order.

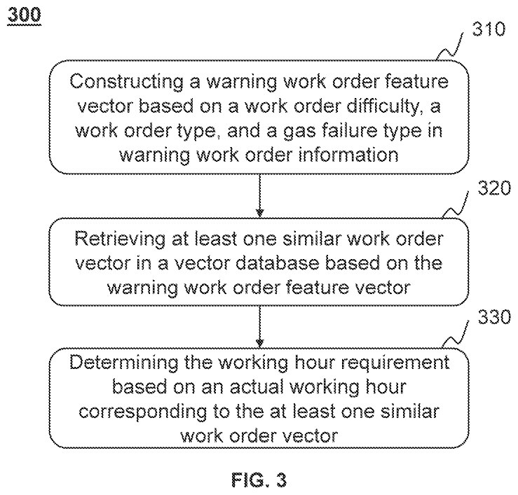

In some embodiments, the working hour requirement may be determined by looking up a table of data of work orders processed by the current handler. In some embodiments, the smart gas management platform 130 may organize the data of the work orders processed by the current handler into a data comparison table and determine the working hour requirement based on the data comparison table. For more descriptions about the working hour requirement, please refer to FIG. 3 and its related descriptions.

In 240, predicting an on-time processing probability of the warning work order based on the working hour requirement, a required completion time, and a work order status.

For descriptions about the required completion time, please refer to descriptions in the operation 210.

The work order status refers to a processing status of the gas work order. The work order status may include a not started status, an on-the-way status, a processing status, a completed status, etc.

The on-time processing probability refers to a probability that the warning work order can be processed and completed on time.

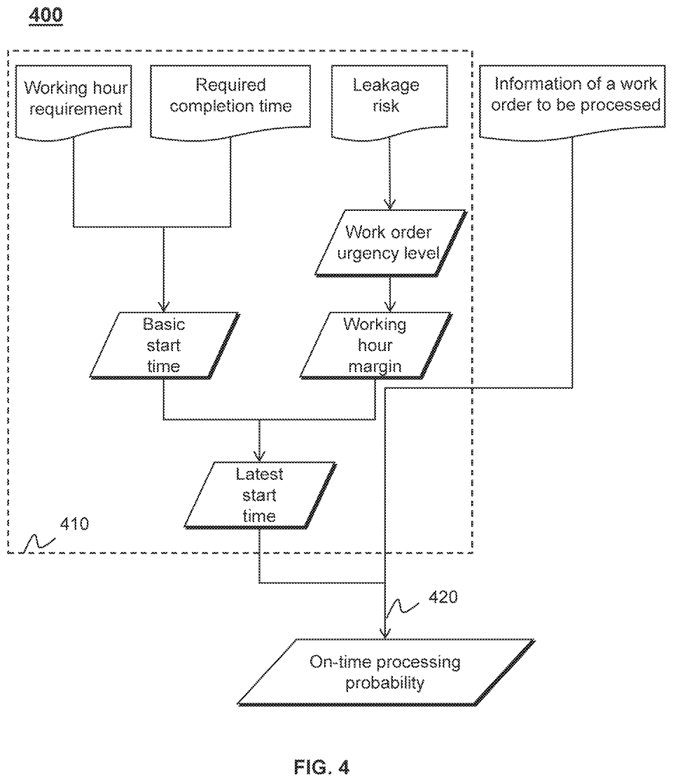

In some embodiments, the smart gas management platform 130 may predict a probability of completing the warning work order before the required completion time, i.e., the on-time processing probability, according to the working hour requirement, the required completion time, and the work order status of the warning work order. For more descriptions, please refer to related descriptions in FIG. 4.

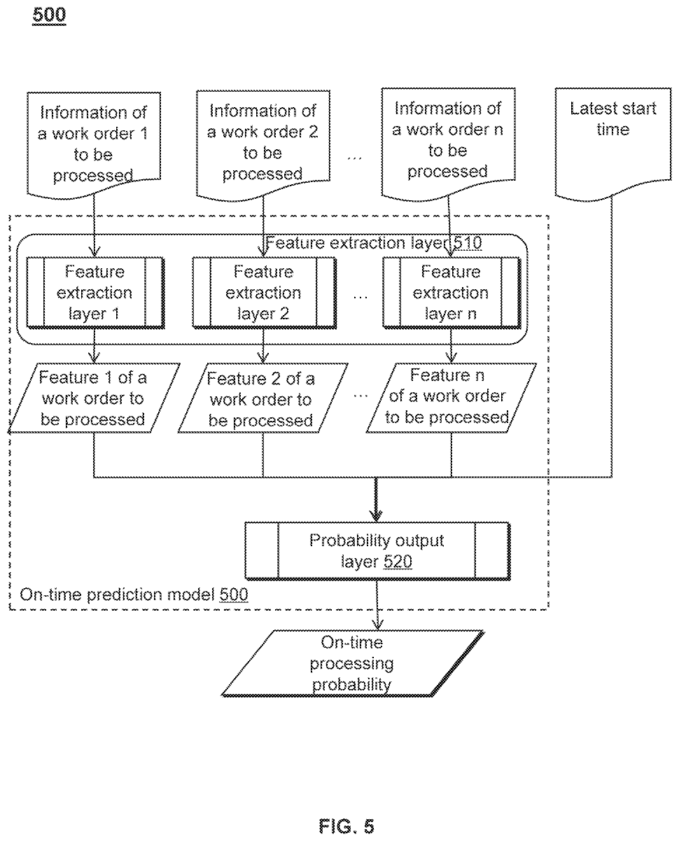

In some embodiments, the on-time processing probability is also related to work experience of the current handler of the working order. The smart gas management platform 130 may predict the on-time processing probability according to a total count of similar work orders processed by the current handler and a count of similar work orders successfully processed by the current handler on time. For example, a ratio of the count of similar work orders successfully processed on time to the total count of similar work orders may be determined as the on-time processing probability. For more description about the on-time processing probability, please refer to FIG. 5 and its related descriptions.

In 250, in response to a determination that the on-time processing probability does not meet a preset probability condition, adjusting a processing scheme of the warning work order. The processing scheme includes at least one of a processing sequence or a handler arrangement.

The preset probability condition refers to a condition that the processing scheme of the warning work order does not need to be adjusted. The preset probability condition at least includes a minimum probability threshold that the on-time processing probability can achieve. The minimum probability threshold may be a minimum on-time processing probability value of this type of the warning work order. For example, the preset probability condition may be that an on-time processing probability of “change a gas pipeline of a certain community” is greater than a minimum probability threshold (e.g., 70%) of the gas pipeline change category.

The processing scheme refers to a scheme for processing the warning work order. The processing scheme may include at least one of the processing sequence or the handler arrangement of the warning work order.

In some embodiments, the smart gas management platform 130 may redetermine the processing scheme of the warning work order and may redetermine the processing scheme by adjusting a processing sequence of a work order to be processed of the current handler or adjusting a handler of the work order.

In some embodiments, adjustment content of the processing scheme may be the handler arrangement. For example, the adjustment of the processing scheme may be to replace a current handler A of the warning work order A with a handler B.

In some embodiments, the adjustment content of the processing scheme may be an arrangement of the processing sequence. The adjustment of the processing scheme may be that a processing sequence of a warning work order B is adjusted to the front, and other work orders to be processed are adjusted backward or supplemented in turn.

In some embodiments of the present disclosure, the on-time processing probability of the warning work order may be predicted, and the processing scheme of the warning work order may be effectively adjusted based on the on-time processing probability, which can ensure that the gas work order can be completed in time and avoid a safety risk caused by untimely processing of the gas work order.

FIG. 3 is a flowchart illustrating an exemplary process for determining a working hour requirement based on a warning work order feature vector according to some embodiments of the present disclosure. As shown in FIG. 3, the process 300 includes the following operations. In some embodiments, the process 300 may be executed by the smart gas management platform 130.

In 310, constructing a warning work order feature vector based on a work order difficulty, a work order type, and a gas failure type in warning work order information.

In some embodiments, the work order difficulty is related to a count of suspicious gas components of a gas failure, and the gas failure type corresponding to the gas failure is related to whether the count of suspicious gas components of the gas failure meets a preset abnormal condition.

The gas failure type refers to a failure type related to gas. In some embodiments, the gas failure type may include an ignition abnormity, a combustion abnormity, a leakage, or the like.

The suspicious gas component refers to a component related to the gas failure. In some embodiments, all components related to the gas failure type are the suspicious gas components, and the work order difficulty is related to the count of suspicious gas components of the gas failure. The greater the count of suspicious gas components, the greater the work order difficulty.

The preset abnormal condition refers to a condition that causes a corresponding gas failure type. The preset abnormal condition may include an abnormal condition that leads to the gas failure such as the ignition abnormity, a combustion abnormity, or the leakage. The abnormal condition refers to that a count of suspicious gas components of a certain type of gas failure is greater than or equal to a preset count. Different gas failure types correspond to different preset abnormal conditions. For example, a preset abnormal condition of the ignition abnormity may be that the count of suspicious gas components is greater than or equal to 6.

The work order type refers to a type of gas work order that requires a different processing scheme. In some embodiments, the work order type may at least include a gas failure repair category, a gas pipeline change category, or the like.

The warning work order feature vector refers to a vector constructed based on feature information of the warning work order. The feature vector may be constructed based on the feature information of the warning work order in various ways. For example, the feature vector q is constructed based on a feature (x, y, z) corresponding to the warning work order, where the feature (x, y, z) may indicate that the work order difficulty corresponding to the warning work order is x, the work order type corresponding to the warning work order is y, and the gas failure type corresponding to the warning work order is z.

In 320, retrieving at least one similar work order vector in a vector database based on the warning work order feature vector, the vector database being constructed based on a work order processing record of the current handler.

In some embodiments, the smart gas management platform 130 may construct the vector database based on work order data processed by the current handler. The vector database may include a plurality of reference work order vectors, and each reference work order vector has a corresponding actual processing working hour. The reference work order vector refers to a vector constructed based on the work order processing record of the current handler. The reference work order vector may be constructed based on the work order processing record of the current handler in various ways. For a way to construct the reference work order vector, please refer to the way to construction the feature vector q.

The similar work order vector refers to a reference work order vector with a minimum vector distance from the warning work order feature vector (a reference work order vector with a highest similarity with the warning work order feature vector) or a reference work order vector with a vector distance from the warning work order feature vector smaller than a distance threshold. A way to calculate the vector distance may include a Euclidean distance, etc.

In some embodiments, the smart gas management platform 130 uses the reference work order vector with the minimum vector distance from the warning work order feature vector or the reference work order vector with a vector distance from the warning work order feature vector smaller than the distance threshold as the similar work order vector by retrieving in the vector database using the warning work order feature vector and obtains the actual processing working hour corresponding to the similar work order vector.

In 330, determining the working hour requirement based on an actual working hour corresponding to the at least one similar work order vector.

The smart gas management platform 130 may determine an average value of the actual working hour corresponding to the at least one similar work order vector as the working hour requirement.

In some embodiments, the smart gas management platform 130 may determine the working hour requirement by performing weighted summation on the actual working hour based on a weight corresponding to the at least one similar work order vector.

In some embodiments, a weight corresponding to each similar work order vector is related to a proficiency of the current handler in processing the similar work order vector. In some embodiments, the proficiency is determined based on a count of work orders processed and a coverage rate of gas failure type when the current handler processes the similar work order vector. For example, a numerical value of the coverage rate of gas failure type may be determined as the proficiency of a handler, and the larger the numerical value, the higher the proficiency of the handler.

In some embodiments, the coverage rate of gas failure type is determined based on a count of gas failure types that have been processed and a total count of gas failure types. For example, a ratio of the count of gas failure types that have been processed to the total count of gas failure types may be determined as the coverage rate of gas failure type.

In some embodiments, the weight corresponding to the each similar work order vector is also related to a time when the current handler processes the similar work order vector. For example, the closer the time of processing the similar work order vector to a current time, the greater the weight.

The weight refers to a ratio of the actual working hour corresponding to the similar work order vector used in determining the working hour requirement. In some embodiments, the higher the proficiency of the current handler in processing a work order type corresponding to the similar work order vector, and/or the closer the time of processing the similar work order vector to the current time, the greater the weight of the actual working hour corresponding to the similar working hour vector used in determining the working hour requirement.

Considering that if the handler has not processed a certain type of task for a long time, the proficiency of the hander may decline. Therefore, when a proficiency corresponding to the handler processing a task closest to the current time of the similar work order vector is not a highest proficiency in history, priority is given to determining the weight based on a degree of closeness of the time when the similar work order is processed to the current time, so as to avoid the rationality of the weight being affected by proficiency reduction due to a long processing interval.

The proficiency of the similar work order vector refers to a proficiency of the handler in processing the work order type corresponding to the similar work order vector. In some embodiments, the proficiency of the work order type corresponding to the similar work order vector may be classified into high, medium, and low.

The coverage rate of gas failure type may be a ratio of covered gas failure types to total gas failure types. The covered gas failure types refer to gas failure types of a work order processed by the handler. In some embodiments, the higher the coverage rate of gas failure type of the handler, i.e., the more comprehensive the corresponding work order type processed by the handler, the higher the proficiency of the handler in processing the corresponding work order type. For example, if there are 100 subtypes of the work order type of the gas failure repair category, and work orders processed by handler A involve 87 subtypes, for the gas failure repair category, the coverage rate of gas failure type of the handler A is 87%, and the coverage rate of gas failure type of an 87% may be directly determined as proficiency of the handler A in processing the gas failure repair category (or determined by looking up a table, etc.).

In some embodiments, the smart gas management platform 130 may assign the weight of the actual working hour corresponding to the at least one similar work order vector based on the proficiency of the current handler in processing a task of a same work order type as the similar work order vector and/or the degree of closeness of the time when the current handler processes the task with the same work order type as the similar work order vector to the current time. The higher the proficiency and/or the closer to the current time when processing the task with the same work order type as the similar work order vector, the greater the weight assigned to the actual working hour. The weighted summation is performed on the actual working hour corresponding to the at least one similar work order vector, and a result of the weighted summation is determined as the working hour requirement. For example, the smart gas management platform 130 retrieves the similar work order vector of the current handler A processing the gas failure repair category and obtains two similar work order vectors, and processing times corresponding to the two similar work order vectors are two months ago and one month ago, respectively and proficiencies corresponding to the two similar work order vectors are 70% and 80%, respectively, so the weight assigned to the actual working hour corresponding to the similar work order vector which is processed one month ago is greater than of the weight assigned to the actual working hour corresponding to the similar work order vectors which is processed two months ago, and finally the working hour requirement is obtained by performing weighted summation on the actual working hours according to the weights assigned to the actual working hours.

In some embodiments of the present disclosure, the weight of the actual working hour corresponding to the at least one similar work order vector is reasonably assigned based on processing experience of the current handler, to avoid the inability to effectively determine the working hour requirement due to insufficient work order data processed by the handler, which in turn helps to determine a more reasonable working hour requirement.

In some embodiments of the present disclosure, the data of the current handler is used to construct the database to determine the working hour requirement, and the determined working hour requirement is more in line with an actual level of the current handler, thereby effectively avoiding a problem that the warning work order fails to be completed in time due to an inaccurate working hour requirement.

FIG. 4 is a flowchart illustrating an exemplary process for predicting an on-time processing probability according to some embodiments of the present disclosure.

In 410, determining a latest start time of a warning work order based on a working hour requirement, a required completion time, and a gas leakage risk.

The gas leakage risk refers to a possibility of a gas leakage incident. The higher the gas leakage risk, the greater the possibility of the gas leakage incident on a gas device. The gas leakage risk may be expressed in various ways. For example, the gas leakage risk may be expressed as a numerical value from 0 to 100, and the larger the numerical value, the higher the gas leakage risk.

In some embodiments, the gas leakage risk may be determined based on data related to a leakage stored in a smart gas data center. The data related to the leakage includes a gas device repair record and user feedback data related to the gas leakage. For example, if it is recorded in a historical repair record of gas device A that “a possibility of subsequent gas leakage is relatively low,” then the gas leakage risk of the gas device A is relatively low.

In some embodiments, the smart gas management platform 130 may determine the gas leakage risk based on a gas component aging feature, a gas usage risk feature, and a user location feature.

In some embodiments, the gas component aging feature includes an appearance situation, a duration of usage, etc. of the gas component. The more severe the aging of the appearance of the gas component and the longer the gas component has been used, the higher the gas leakage risk. The gas component aging feature may be obtained based on information uploaded by a user and by querying an installation record and a repair record, etc.

In some embodiments, the gas usage risk feature refers to an abnormal event that may occur during gas usage. For example, the gas usage risk feature may include a situation such as a failure to ignite several times, peculiar smell, abnormal flames (e.g., an abnormal flame color), or abnormal gas meter usage (e.g., a sudden increase in gas usage compared to usual) during the gas usage. The gas usage risk feature may be determined by failure content filled in by a user when a work order is submitted. When there are one or more gas usage risk features in the failure content fed back by the user, the gas leakage risk increases.

In some embodiments, the user location feature may include location information of a gas device. The user location feature may be judged according to a gas user type. The gas user type may include a commercial user, an industrial user, or the like. For example, if a user is a commercial user, the gas device of the user may be used for catering, there may be a relatively large flow of dense crowd, and there are many unsafe factors that may easily lead to a gas leakage, the gas leakage risk increases. The user location feature may be obtained based on the information uploaded by the user, by querying the installation record, etc.

A start time refers to a time when a handler starts processing the warning work order. The latest start time refers to a latest time to start processing the warning work order.

In some embodiments, the smart gas management platform 130 may determine the latest start time by analyzing and processing data related to at least one of the working hour requirement, the required completion time, or the gas leakage risk by modeling or using various data analysis algorithms (e.g., regression analysis, discriminant analysis).

In some embodiments, the smart gas management platform 130 may determine a basic start time based on the working hour requirement and the required completion time; determining a work order urgency level based on the gas leakage risk; determining a working hour margin based on the work order urgency level; and determining the latest start time based on the basic start time and the working hour margin.

The basic start time refers to a basic time when the handler starts processing the warning work order. In some embodiments, the basic start time may be calculated by subtracting the working hour requirement from the required completion time. For example, if a required completion time of warning work order A is 17:00, and a working hour requirement is 3 hours, a basic start time of the warning work order A is 14:00.

The work order urgency level refers to an importance level of the work order. In some embodiments, the work order urgency level may be determined based on the gas leakage risk. The higher the gas leakage risk, the higher the work order urgency level.

The working hour margin refers to a time that is relaxed based on the working hour requirement. In some embodiments, the working hour margin may also be determined based on the work order urgency level, and the higher the work order urgency level, the longer the working hour margin.

In some embodiments, the latest start time may be calculated by subtracting the working hour requirement and the working hour margin from the required completion time. For example, the required completion time of warning work order A is 17:00, and the working hour requirement is 3 hours. In order to ensure that the warning work order A is completed on time as much as possible, a 0.5-hour working hour margin is given, i.e., the warning work order A needs to be processed at 13:30 at the latest. If a work order urgency level of the work order is relatively high, and in order to ensure that the work order is completed on time as much as possible, the working hour margin may be even longer, for example, the working hour margin is increased to 1 hour, the work order needs to be processed at 13:00 at the latest.

In some embodiments of the present disclosure, the working hour margin may be determined based on the work order urgency level, which can further ensure that the warning work order can be completed on time, thereby helping to determine a more reasonable latest start time of the warning work order, and avoiding a safety risk caused by untimely processing of the gas work order.

In 420, predicting the on-time processing probability based on the latest start time and information of a work order to be processed of the current handler.

The information of the work order to be processed refers to information of a work order waiting to be processed by the handler. In some embodiments, the information of the work order to be processed may include at least one of a work order difficulty, a work order type, or a gas failure type of a work order to be processed. Specific information of the work order to be processed is similar to that of the warning work order. For more descriptions, please refer to FIG. 2 and its related descriptions.

In some embodiments, the smart gas management platform 130 may determine an estimated completion time and a location of a gas failure of a current work order to be processed based on information of the current work order to be processed, based on a location A of a gas failure of the current work order to be processed and a location B of a gas failure of a warning work order, determine a required travel time from location A to location B, and calculate a time difference between the estimated completion time of the current work order to be processed and the latest start time of the warning work order, and determine the on-time processing probability based on the travel time and the time difference. The smaller the travel time, and the larger the time difference, the greater the on-time processing probability. In response to a determination that the travel time is smaller than the time difference, and the greater the difference between the travel time and the time difference, the greater the on-time processing probability. If the travel time is greater than the time difference, or a work order starts being processed after the latest start time, the on-time processing probability approaches 0.

In some embodiments, the on-time processing probability may also be predicted by an on-time prediction model, which may be found in FIG. 5 and its related descriptions.

In some embodiments of the present disclosure, the latest start time of the warning work order may be determined based on the working hour requirement, the required completion time, and the gas leakage risk of the warning work order and the on-time processing probability of the warning work order may be predicted based on the latest start time and the information of the work order to be processed, which is conducive to determining the on-time processing probability in real time according to an actual processing situation of the current handler and is conducive to timely adjusting a processing scheme of the warning work order based on the on-time processing probability, thereby ensuring that the gas work order can be completed in time and avoiding a safety risk caused by untimely processing of the gas work order.

FIG. 5 is a schematic diagram illustrating an on-time prediction model according to some embodiments of the present disclosure.

In some embodiments, the smart gas management platform 130 may predict an on-time processing probability through the on-time prediction model processing information of other work orders to be processed. The information of the other work orders to be processed refers to information of a work order to be processed of a current handler except for a warning work order, and the on-time prediction model is a machine learning model.

The on-time prediction model 500 is a model used to determine the on-time processing probability. In some embodiments, the on-time prediction model 500 may be a machine learning model, for example, the on-time prediction model 500 may include various feasible models such as a recurrent neural network (RNN) model, a deep neural network (DNN) model, a convolution neural network (CNN), or the like, or any combination thereof.

In some embodiments, an input of the on-time prediction model 500 may include the information of the other work orders to be processed. An output of the on-time prediction model 500 may include the on-time processing probability. For more descriptions about the on-time processing probability, please refer to FIG. 2 and its related descriptions.

The information of the other work orders to be processed refers to the information of the work order to be processed except for the warning work order.

In some embodiments, the on-time prediction model 500 includes a feature extraction layer 510 and a probability output layer 520. The feature extraction layer 510 is configured to determine a plurality of features of the work order to be processed based on the information of the other work orders to be processed. The probability output layer 520 is configured to determine the on-time processing probability based on the plurality of features of the work order to be processed and a latest start time. For more descriptions about the latest start time, please refer to FIG. 4 and its related descriptions.

In some embodiments, the feature of the work order to be processed may include a work order difficulty, a work order type, or a gas failure type of the work order to be processed, or the like, or any combination thereof.

The feature extraction layer 510 is composed of a plurality of feature extraction layers, such as a feature extraction layer 1, a feature extraction layer 2, . . . , and a feature extraction layer n shown in FIG. 5. An input of the feature extraction layer 510 includes information of the at least one other work order to be processed, one feature extraction layer corresponds to information of one work order to be processed, and an output of the feature extraction layer 510 includes at least one feature of the work order to be processed. For example, information of a work order 1 to be processed is input into a feature extraction layer 1, and the output is a feature 1 of the work order to be processed. The at least one feature of the work order to be processed output by the feature extraction layer 510 may be used as an input of the probability output layer 520.

An input of the probability output layer 520 includes the at least one feature of the work order to be processed and the latest start time, and an output of the probability output layer 520 is the on-time processing probability.

In some embodiments, the on-time prediction model 500 may be obtained through joint training. A first training sample used for the joint training may include a latest start time of a sample warning work order and information of a sample work order to be processed. The sample work order to be processed refers to an unprocessed work order before the sample warning work order at a time of warning, and the first training sample is from historical processing data. A label of the first training sample is an actual on-time processing probability of the sample warning work order. The label may be from historical data or manually labeled.

Merely by way of example, based on the historical data, a count of warning work orders processed on time under different work order difficulties and work order types may be counted manually, and a ratio of a count of similar work orders processed on time to a total count of processed similar work orders may be calculated manually, to determine an actual on-time processing probability. For example, the on-time processing probability may be any value between 0 and 1, where 0 indicates that the warning work order cannot be processed on time, 1 indicates that the warning work order can be processed on time, and other values between 0 and 1 indicate that the warning work order may be processed on time. A magnitude of the value indicates a probability of processing the warning work order on time.

A process of the joint training of the on-time prediction model includes: inputting information of one or more sample work orders to be processed into one or more feature extraction layers to obtain one or more features of the sample work orders to be processed output by the one or more feature extraction layers, inputting the one or more features of the sample work orders to be processed and the latest start time of the sample warning work order into the probability output layer to obtain the on-time processing probability of the sample warning work order output by the probability output layer, constructing a loss function based on the label and a result of the probability output layer, updating a parameter of the feature extraction layer and the probability output layer, completing the module training when the loss function meets a preset condition, and obtaining a trained on-time prediction model. The preset condition may be that the loss function converges, a count of iterations reaches a threshold of a count of iterations, etc.

The trained on-time prediction model may be obtained through the joint training, which is conducive to solving a problem that the label is difficult to obtain when the feature extraction layer is trained separately in some cases. At the same time, the trained on-time prediction model may be obtained based on the joint training, which can make the on-time prediction model better obtain the on-time prediction probability.

In some embodiments, the input of each feature extraction layer further includes a first sub-score corresponding to the work order to be processed. The input of the probability output layer also includes current handler information and traffic information. The traffic information is input according to a processing order of the work order to be processed. For more descriptions about the current handler information, please refer to FIG. 2 and its related descriptions.

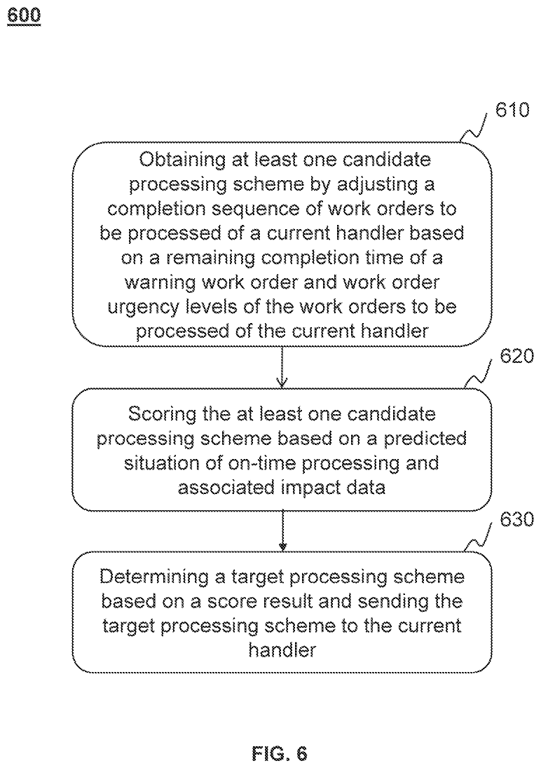

The first sub-score is related to a predicted situation of on-time processing. In some embodiments, the better the predicted situation of on-time processing of the work order to be processed before the warning work order is, the higher the first sub-score is, and the higher the accuracy of an estimated on-time probability of the warning work order is. For more descriptions about the first sub-score and the predicted situation of on-time processing, please refer to FIG. 6 and its related descriptions.

The traffic information refers to available information related to traffic. For example, the traffic information may include a route and time from a gas failure location of a work order A to be processed to a gas failure location of a work order B to be processed. If there is a plurality of work orders to be processed, the traffic information may include a total route and time from the gas failure location of the work order A to be processed to the gas failure location of the work order B to be processed, and from the gas failure location of the work order B to be processed to a gas failure location of a work order C to be processed.

When the input of the feature extraction layer also includes the first sub-score corresponding to the work order to be processed, the current handler information, and the traffic information, the first training sample may also include a first sub-score of the sample work order to be processed, sample current handler information, and sample traffic information, and the rest of the training process may be found in the relevant descriptions above.

In some embodiments of the present disclosure, the on-time processing probability may be determined through the on-time prediction model, which can fully consider an impact of the information of the work order to be processed and the latest start time on the on-time processing probability, and key point information of the work order to be processed may be extracted based on the feature extraction layer, which can improve the accuracy of predicting the on-time processing probability. Furthermore, the first sub-score, the current handler information, and the traffic information may be added into the input, which can make the predicted on-time processing probability more accurate and more realistic.

FIG. 6 is a flowchart illustrating an exemplary process for adjusting a processing scheme of a warning work order according to some embodiments of the present disclosure.

In 610, obtaining at least one candidate processing scheme by adjusting a completion sequence of work orders to be processed of a current handler based on a remaining completion time of a warning work order and work order urgency levels of the work orders to be processed of the current handler.

The remaining completion time refers to a length of time between a current time and a required completion time of the warning work order. For example, if the current time is 13:00, and the required completion time of the warning work order is 17:00, the remaining completion time is 4 hours.

The candidate processing scheme refers to one or more processing schemes selected to be used to adjust the completion sequence of the work orders to be processed. For example, the completion sequence of the current work orders to be processed is work order A, work order B, and work order C. The completion sequence is adjusted based on the work order urgency levels and the remaining completion time, and a work order with a higher work order urgency level and a shorter remaining completion time is adjusted to be processed earlier, so the candidate processing scheme can be work order A, work order C, and work order B or the candidate processing scheme can also be work order B, work order C, and work order A, etc.

In 620, scoring the at least one candidate processing scheme based on a predicted situation of on-time processing and associated impact data, the associated impact data including at least one of a count or an affected time of affected gas users around an area where a gas work order is located when the gas work order is processed.

The predicted situation of on-time processing refers to a probability that the warning work order will be processed on time. In some embodiments, the predicted situation of on-time processing is related to a processing time and the required completion time, and the processing time may be determined by a processing sequence, a working hour requirement, and traffic time.

The associated impact refers to a possible impact on the other users. For example, when a gas work order is processed, the other gas users in the area where the gas work order is located may be affected. The associated impact data may be data related to the associated impact. For example, the associated impact data may include the count, the affected time of the affected gas users around the area where the gas work order is located when the gas work order is processed, etc.

In some embodiments, one or more work orders to be processed in the candidate processing scheme may be scored, and a score of the candidate processing scheme may be determined based on the scores of the one or more work orders to be processed.

In some embodiments, the smart gas management platform 130 may determine a first sub-score of the work order to be processed in the candidate processing scheme based on the predicted situation of on-time processing. For example, if the processing time exceeds the required completion time, the predicted situation of on-time processing may become worse, and the more the processing time exceeds the required completion time, the less ideal the predicted situation of on-time processing, and the lower the corresponding first sub-score. If the processing time is before the required completion time, the predicted situation of on-time processing may be better, and the more the processing time is earlier than the required completion time, the greater the first sub-score. However, the first sub-score cannot exceed a first threshold. The first threshold refers to an upper limit of the first sub-score of the work order to be processed. The first threshold may be a system default value, a system value, an artificial preset value, or the like, or any combination thereof, which may be set according to an actual need.

In some embodiments, the smart gas management platform 130 may determine a second sub-score of the work order to be processed in the candidate processing scheme based on the associated impact data. For example, the less the impact on the other gas users around the area where the gas work order is located, the higher the second sub-score. However, the second sub-score cannot exceed a second threshold. The second threshold refers to an upper limit of the second sub-score of the work order to be processed. The second threshold may be a system default value, an empirical value, an artificial preset value, or the like, or any combination thereof, which may be set according to an actual need.

In some embodiments, the associated impact data may be determined by analyzing and processing the count and/or an affected time of the affected gas users around the area where the gas work is located by modeling or using various data analysis algorithms (e.g., regression analysis, discriminant analysis).

In some embodiments, the smart gas management platform 130 may determine the associated impact data through an associated impact model. An input of the associated impact model may include gas work order information, a regional gas pipeline network map, and a predicted processing time. An output of the associated impact model includes the associated impact data.

The gas work order information may at least include a work order difficulty, a work order type, a gas failure type of the gas work order, or any combination thereof. Specific information about the gas work order information is similar to that of the warning work order. For more descriptions, please refer to FIG. 2 and its related descriptions.

The regional gas pipeline network map refers to a distribution map of the gas pipeline network of the area where the gas work order is located. The smart gas management platform 130 may obtain the regional gas pipeline network map from a smart gas data center.

The predicted processing time may include the working hour requirement, traffic time, etc. of the gas work order. In some embodiments, the predicted processing time may be determined based on the sequence of the candidate processing scheme.

The associated impact model may be obtained by training a large amount of second training samples with labels. The second training sample used for training may include information of a sample gas work order, a regional gas pipeline network map of the sample gas work order, and an actual processing time. The second training sample may be from historical processing data. The label of the second training sample is actual associated impact data. The label may be from historical data or manually labeled. Merely by way of example, according to the historical data, the historical data, to determine the actual associated impact data.

An exemplary training process of the associated impact model includes: inputting a plurality of second training samples with labels into an initial associated impact model, constructing a loss function through the labels and a result of the initial associated impact model, iteratively updating a parameter of the initial association impact model through gradient descent or other manners based on the loss function, completing the module training when a preset condition is met, and obtaining a trained associated impact model. The preset condition may be that the loss function converges, a count of iterations reaches a threshold, etc.

In some embodiments of the present disclosure, the associated impact data may be determined through the associated impact model, which can fully consider the impact on the surrounding users when the gas work order is processed and improve the accuracy of calculating the associated impact data.

A sub-score is related to the first sub-score and the second sub-score. In some embodiments, the smart gas management platform 130 may determine a sub-score of the work order to be processed based on the first sub-score and the second sub-score, and determine the score of the candidate processing scheme by performing weighted summation on the sub-scores of the of the candidate work orders to be processed in the candidate processing scheme. In some embodiments, based on the one or more work orders to be processed, a weight of a sub-score of a warning work order is greater than a preset weight threshold (e.g., a preset weight threshold is 50%).

In some embodiments, weights of sub-scores of a plurality of work orders to be processed that do not contain the warning work order are equal in the score of the candidate processing scheme.

In some embodiments, the weights of the sub-scores of the plurality of work orders to be processed in the score of the candidate processing scheme are related to a gas leakage risk. The higher the gas leakage risk, the higher the weight of the sub-score corresponding to the work order to be processed.

In some embodiments of the present disclosure, the first sub-score is determined by the predicted situation of on-time processing, the second sub-score is determined by the associated impact data, the score of the candidate scheme is determined based on the first sub-score and the second sub-score, and a more reasonable scheme is determined based on the score of the candidate scheme. Furthermore, the weight of the sub-score of the work order to be processed may be determined based on the gas leakage risk, which can further ensure rationality in scoring the candidate processing scheme, thereby in turn helping to determine a processing scheme that is more in line with an actual need and avoiding a safety risk caused by untimely processing of the gas work order.

In 630, determining a target processing scheme based on a score result and sending the target processing scheme to the current handler.

In some embodiments, the score result refers to a result of ranking the scores of the candidate processing schemes.

The target processing scheme refers to a processing scheme used to adjust the warning work order. In some embodiments, the target processing scheme may be a candidate processing scheme with a highest score.

In some embodiments, the smart gas management platform 130 may determine a processing scheme set based on the candidate processing scheme and determine the target processing scheme by performing at least one round of iterative update based on the processing scheme set. The at least one round of iterative update includes performing a change operation on a processing sequence of at least one work order to be processed of the candidate processing scheme. The at least one work order to be processed whose processing sequence is performed by a change operation at least includes the warning work order. The change operation includes: exchanging a processing sequence of the at least one work order to be processed of the candidate processing scheme; or adjusting the processing sequence of the at least one work order to be processed of the candidate processing scheme, and sequentially adjusting backward or supplementing processing sequences of other work orders to be processed.

In some embodiments, the smart gas management platform 130 may encode the candidate processing scheme in various ways, for example, the candidate processing scheme is expressed as {x1, x2, x3, x4, x5, . . . , xn}, where x1, x2, . . . , xn represents the work order to be processed, and the ranking position in a sequence is the corresponding processing sequences.

In some embodiments, a sequence of the warning work order in an original processing sequence is advanced to a different position, and/or sequences of other work orders are changed to obtain a plurality of candidate processing schemes to form the processing scheme set.

In some embodiments, the smart gas management platform 130 may score the work order to be processed and its processing sequence in the processing scheme set, and evaluate the processing scheme set based on the score. For descriptions about the scoring, please refer to the operation 620 and its related descriptions.

In some embodiments, the smart gas management platform 130 may update the processing scheme set, and the update may include updating a code corresponding to the candidate processing scheme. In some embodiments, the update refers to the change operation of adjusting or exchanging the processing sequence of the at least one work order to be processed. For example, when a fifth work order to be processed (x5) of the candidate processing scheme {x1, x2, x3, x4, x5, . . . , xn} is adjusted to a third position, and the original x3 and x4 are adjusted backward, an adjusted candidate processing scheme is denoted as {x1, x2, x5, x3, x4, . . . , xn}.

In some embodiments, in the updated new candidate processing schemes, a better one may be selected from the candidate processing schemes based on the score to enter a next round of iteration.

In some embodiments, there are a plurality of types of iteration end conditions. For example, the iteration end conditions include a score of a certain candidate processing scheme is greater than a preset threshold, a count of iterations reaches a maximum value when the score is smaller than or equal to the preset threshold, etc. In response to a determination that the iteration meets the iteration end condition, the iteration ends. In some embodiments, when the iteration ends, if there are candidate processing schemes whose scores are greater than the preset threshold, a candidate processing scheme with a highest score may be output, and the candidate processing scheme is determined as the target processing scheme. In some embodiments, there is no candidate processing scheme whose score is greater than the preset threshold when the count of iterations reaches the maximum value, the smart gas management platform 130 may obtain a target handler meeting a preset matching condition to process the warning work order.

In some embodiments, all candidate processing sequences of the at least one candidate processing scheme are scored; adjusting a processing scheme of the warning work order includes: in response to a determination that the score results corresponding to all the candidate processing sequences of the at least one candidate processing scheme meeting a preset threshold condition, determining the target handler meeting the preset matching condition; and sending the warning work order and a latest start time of the warning work order to the target handler.

The candidate processing sequence refers to processing sequences of work orders to be processed of the candidate processing scheme. For example, various candidate processing sequences may be determined by permutation and combination.

The preset threshold condition includes that the score of the candidate processing sequence is smaller than a preset score threshold. For example, the score threshold condition may be an artificial preset value, which can be set according to an actual need.

The preset matching condition refers to a level and/or ability of a handler that is sufficient to process the warning work order. The target handler meeting the preset matching condition refers to a handler whose level and/or ability can correspond to a work order difficulty and a work order type of the warning work order.

In some embodiments, when a count of handlers meeting the preset matching condition is more than one, the warning work order is added to a work order to be processed of the plurality of handlers according to the latest start time of the warning work order, and by scoring a sequence of work orders to be processed including the warning work order, the warning work order is given to a handler corresponding to a highest score. For more descriptions about the scoring the work order to be processed, please refer to FIG. 5, the operation 620 and their related descriptions. For example, if the latest start time of the warning work order is 15:00, the warning work order may be placed at 15:00 and earlier. As another example, if in an original scheme, an end time of a work order 1 is 14:40, and an end time of a work order 2 is 15:50, the warning work order may be placed before the work order 2, and the work order 2 may be adjusted backward.

In some embodiments of the present disclosure, in response to a determination that the scores of all candidate processing sequences are smaller than the preset threshold, a handler who can process a corresponding work order difficulty and work order type may be searched for, and adjust the processing scheme by adjusting and replacing the handler, which can further ensure the rationality of the candidate processing scheme. When the count of handlers meeting the condition is more than one, the sequence of work orders to be processed including the warning work order may be scored, and the handler corresponding to the highest score may be selected, which can help to determine a more feasible processing scheme and reduce a safety risk caused by untimely processing of the gas work order.

In some embodiments of the present disclosure, the target processing scheme may be determined through the iteration, and the processing scheme set may be continuously updated and selected through scoring, which can quickly determine an optimized processing scheme that meets the requirement and improve the efficiency of determining the target processing scheme.

In some embodiments, after the target processing scheme is determined, the smart gas management platform 130 may transfer the target processing scheme to the smart gas service platform 120, and the smart gas service platform 120 sends the target processing scheme to the smart gas user platform 110. The smart gas user platform 110 informs the user the target processing scheme.

In some embodiments of the present disclosure, the at least one candidate processing scheme may be generated based on the work order urgency levels and the remaining completion time of the warning work order, the at least one candidate processing scheme may be scored through the predicted situation of on-time processing and the associated impact data, and the processing scheme of the warning work order may be adjusted based on the score, which can reasonably determine the optimized processing scheme that meets the requirement, help to determine a more feasible processing scheme, and avoid a safety risk caused by the untimely processing of the gas work order.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. By way of example, should there be any inconsistency or conflict between the description, definition, and/or the use of a term associated with any of the incorporated material and that associated with the present document, the description, definition, and/or the use of the term in the present document shall prevail.

What is claimed is:

1. A method for dynamically managing a work order of a smart gas platform, implemented by a smart gas management platform of an Internet of Things system for dynamically managing a work order of a smart gas platform, comprising:
obtaining real-time data of a gas work order;
determining warning work order information and current handler information of a warning work order based on the real-time data of the gas work order;
determining a working hour requirement of the warning work order according to the warning work order information and the current handler information;
predicting an on-time processing probability of the warning work order based on the working hour requirement, a required completion time, and a work order status; and
in response to a determination that the on-time processing probability does not meet a preset probability condition, adjusting a processing scheme of the warning work order, the processing scheme including at least one of a processing sequence or a handler arrangement.

2. The method of claim 1, wherein the determining a working hour requirement of the warning work order according to the warning work order information and the current handler information includes:
constructing a warning work order feature vector based on a work order difficulty, a work order type, and a gas failure type in the warning work order information;
retrieving at least one similar work order vector in a vector database based on the warning work order feature vector, the vector database being constructed based on a work order processing record of a current handler; and
determining the working hour requirement based on an actual working hour corresponding to the at least one similar work order vector.

3. The method of claim 2, wherein the determining the working hour requirement based on an actual working hour corresponding to the at least one similar work order vector includes: determining the working hour requirement by performing weighted summation on the actual working hour based on a weight corresponding to the at least one similar work order vector;
a weight corresponding to each similar work order vector is related to a proficiency of the current handler in processing the similar work order vector, and the proficiency is determined based on a count of processed work orders and a coverage rate of gas failure type when the current handler processes the similar work order vector; and the coverage rate of gas failure type is determined based on a count of processed gas failure types and a total count of gas failure types.

4. The method of claim 2, wherein the work order difficulty is related to a count of suspicious gas components of a gas failure, and the gas failure type corresponding to the gas failure is related to whether the count of the suspicious gas components of the gas failure meets a preset abnormal condition.

5. The method of claim 1, wherein the predicting an on-time processing probability of the warning work order based on the working hour requirement, a required completion time, and a work order status includes:
determining a latest start time of the warning work order based on the working hour requirement, the required completion time, and a gas leakage risk; and
predicting the on-time processing probability based on the latest start time and information of a work order to be processed of the current handler.

6. The method of claim 5, wherein the determining a latest start time of the warning work order based on the working hour requirement, the required completion time, and a gas leakage risk includes:
determining a basic start time based on the working hour requirement and the required completion time;
determining a work order urgency level based on the gas leakage risk;
determining a working hour margin based on the work order urgency level; and
determining the latest start time based on the basic start time and the working hour margin.

7. The method of claim 5, wherein the predicting the on-time processing probability based on the latest start time and information of a work order to be processed of the current handler includes:
predicting the on-time processing probability through an on-time prediction model processing information of other work orders to be processed; the information of the other work orders to be processed being information of a work order to be processed of the current handler except for the warning work order, and the on-time prediction model being a machine learning model.

8. The method of claim 7, wherein the on-time prediction model includes a plurality of feature extraction layers and a probability output layer;
the plurality of feature extraction layers is configured to determine a plurality of features of a work order to be processed based on the information of the other work orders to be processed; and
the probability output layer is configured to determine the on-time processing probability based on the plurality of features of the work order to be processed and the latest start time.

9. The method of claim 1, wherein the adjusting a processing scheme of the warning work order includes:
obtaining at least one candidate processing scheme by adjusting a completion sequence of work orders to be processed of the current handler based on a remaining completion time of the warning work order and work order urgency levels of the work orders to be processed of the current handler;
scoring the at least one candidate processing scheme based on a predicted situation of on-time processing and associated impact data, the associated impact data including at least one of a count or an affected time of other affected gas users around an area where a gas work order is located when the gas work order is processed; and
determining a target processing scheme based on a score result and sending the target processing scheme to the current handler.

10. The method of claim 9, wherein the scoring includes scoring all candidate processing sequences of the at least one candidate processing scheme; and the adjusting a processing scheme of the warning work order further includes:
in response to a determination that the score results corresponding to all the candidate processing sequences of the at least one candidate processing scheme meet a preset threshold condition, determining a target handler who meets a preset matching condition; and
sending the warning work order and a latest start time of the warning work order to the target handler.

11. An Internet of Things system for dynamically managing a work order of a smart gas platform, comprising a smart gas management platform, wherein the smart gas management platform is configured to:
obtain real-time data of a gas work order;
determine warning work order information and current handler information of a warning work order based on the real-time data of the gas work order;
determine a working hour requirement of the warning work order according to the warning work order information and the current handler information;
predict an on-time processing probability of the warning work order based on the working hour requirement, a required completion time, and a work order status; and
in response to a determination that the on-time processing probability does not meet a preset probability condition, adjust a processing scheme of the warning work order, the processing scheme including at least one of a processing sequence or a handler arrangement.

12. The Internet of Things system of claim 11, further comprising a smart gas user platform, a smart gas service platform, a smart gas sensor network platform, and a smart gas object platform; wherein
the smart gas user platform issues a query instruction for operation management information and/or feedback information of a gas user to the smart gas service platform and receives gas work order visualization information uploaded by the smart gas service platform;
the smart gas service platform receives the query instruction for the operation management information issued by the smart gas user platform and uploads the operation management information to the smart gas user platform; and issues the query instruction for the operation management information to the smart gas management platform and receives the operation management information uploaded by the smart gas management platform;
the smart gas management platform receives the query instruction for the operation management information issued by the smart gas service platform and uploads the operation management information to the smart gas service platform; and issues an instruction for obtaining data related to a gas device to the smart gas sensor network platform and receives the data related to the gas device uploaded by the smart gas sensor network platform;
the smart gas sensor network platform receives the instruction for obtaining the data related to the gas device issued by the smart gas management platform and uploads the data related to the gas device to the smart gas management platform; and issues the instruction for obtaining the data related to the gas device to the smart gas object platform and receives the data related to the gas device uploaded by the smart gas object platform; and
the smart gas object platform receives the instruction for obtaining the data related to the gas device issued by the smart gas sensor network platform and uploads the data related to the gas device to the smart gas sensor network platform.

13. The Internet of Things system of claim 11, wherein the smart gas management platform is further configured to:
construct a warning work order feature vector based on a work order difficulty, a work order type, and a gas failure type in the warning work order information;
retrieve at least one similar work order vector in a vector database based on the warning work order feature vector, the vector database being constructed based on a work order processing record of a current handler; and
determine the working hour requirement based on an actual working hour corresponding to the at least one similar work order vector.

14. The Internet of Things system of claim 13, wherein the smart gas management platform is further configured to: determine the working hour requirement by performing weighted summation on the actual working hour based on a weight corresponding to the at least one similar work order vector;
a weight corresponding to each similar work order vector is related to a proficiency of the current handler in processing the similar work order vector, and the proficiency is determined based on a count of processed work orders and a coverage rate of gas failure type when the current handler processes the similar work order vector; and the coverage rate of gas failure type is determined based on a count of processed gas failure types and a total count of gas failure types.

15. The Internet of Things system of claim 11, wherein the smart gas management platform is further configured to:
determine a latest start time of the warning work order based on the working hour requirement, the required completion time, and a gas leakage risk; and
predict the on-time processing probability based on the latest start time and information of a work order to be processed of the current handler.

16. The Internet of Things system of claim 15, wherein the smart gas management platform is further configured to:
determine a basic start time based on the working hour requirement and the required completion time;
determine a work order urgency level based on the gas leakage risk;
determine a working hour margin based on the work order urgency level; and
determine the latest start time based on the basic start time and the working hour margin.

17. The Internet of Things system of claim 15, wherein the smart gas management platform is further configured to:
predict the on-time processing probability through an on-time prediction model processing information of other work orders to be processed; the information of the other work orders to be processed being information of a work order to be processed of the current handler except for the warning work order, and the on-time prediction model being a machine learning model.

18. A non-transitory computer-readable storage medium storing computer instructions, wherein when reading the computer instructions stored in the storage medium, a computer implements the method of claim 1.
